(19) United States
(12) Patent Application Publication
(10) Pub. No.: US 2007/0223214 A1
(43) Pub. Date: Sep. 27, 2007

(54) TELESCOPIC TOOL PEN WITH AN ILLUMINATION DEVICE

(76) Inventor: MING-HSIEN YEN, Taichung City (TW)

Correspondence Address: BANGER SHIA, 204 CANYON CREEK, VICTORIA, TX, 77901, US

(21) Appl. No.: 11/277,514

(22) Filed: Mar. 26, 2006

(51) Int. Cl. F21V 33/00

(52) U.S. Cl. 362/118; 362/109; 362/398

(57) ABSTRACT

A telescopic tool pen with an illumination device comprises: a tube; a pen head inserted in one end of the tube; a telescopic pipe inserted in the other end of the tube, a lamp holder installed on the mounting seat of the telescopic pipe, a lampshade installed on the lamp holder for encapsulating the LED (light emitting diode), a magnetic member disposed in the mounting recess of the lampshade, a battery assembly arranged between the lamp holder and the telescopic pipe, and an actuator disposed in the telescopic pip. After the telescopic pipe extends out, the actuator will be withdrawn into the telescopic tube, and the spring will push the battery assembly into electrical contact with the ring of the telescopic pipe, thus turning on the LED, thus turning on the LED. When the tool pen is used to attract an accessory lost in the hole, the led can illuminate the location of the accessory, allowing the user to attract the accessory with the annular magnetic member very conveniently.

### BACKGROUND OF THE INVENTION

1. Field of the Invention

The present invention relates to a telescopic tool pen, and more particularly to a telescopic tool pen with an illumination device.

2. Description of the Prior Art

Hand tool used for assembly and maintenance purposes is one of indispensable tools in daily life.

U.S. Pat. No. 5,878,637 discloses a telescopic hand tool that has a magnetic head to be extended outward for attracting and fetching the accessories (such as screws, nuts, washers or the like) lost in a concave, such as a deep hole, a groove.

However, the deep hole of an object is always dark and the accessory lost therein is invisible, so that the user can't fetch it easily with the telescopic and has to fumble in the dark with the telescopic tool to find the accessories.

The present invention has arisen to mitigate and/or obviate the afore-described disadvantages.

### SUMMARY OF THE INVENTION

The primary objective of the present invention is to provide a telescopic tool pen with an illumination device, when it is used to attract an accessory lost in the hole, the led can illuminate the location of the accessory, allowing the user to attract the accessory with the annular magnetic member very conveniently.

A telescopic tool pen with an illumination device in accordance with the present invention comprises: a tube; a pen head inserted in one end of the tube; a telescopic pipe inserted in the other end of the tube, a mounting seat formed at one end of the telescopic pipe, a ring received in the mounting seat; a lamp holder installed on the mounting seat of the telescopic pipe, a LED (light emitting diode) with two electrodes being installed on the other end of the lamp holder, a spring disposed in the lamp holder, one electrode of the LED being electrical contact with the lamp holder, the other electrode of the LED being electrical contact with the spring; a lampshade installed on the lamp holder for encapsulating the LED, a mounting recess formed in the lampshade; a magnetic member disposed in the mounting recess of the lampshade; a battery assembly being arranged between the lamp holder and the telescopic pipe and having a first electrode and a second electrode, and the first electrode of the battery assembly being in electrical contact with and pressed against the spring; and an actuator being disposed in the telescopic pipe in such a manner that one end of the actuator protrudes out of the ring and is pressed against the second electrode of the battery assembly, after the telescopic pipe extends out, the actuator will be withdrawn into the telescopic tube, and the spring will push the battery assembly into electrical contact with the ring of the telescopic pipe, thus turning on the LED.

### BRIEF DESCRIPTION OF THE DRAWINGS

FIG. 1 is a perspective assembly view of a telescopic tool pen with an illumination device in accordance with a preferred embodiment of the present invention;

FIG. 2 is an exploded view of the telescopic tool pen with an illumination device in accordance with the preferred embodiment of the present invention;

FIG. 3 is a cross sectional view of a part of the telescopic tool pen with an illumination device in accordance with the preferred embodiment of the present invention;

FIG. 4 is another cross sectional view of a part of the telescopic tool pen with an illumination device in accordance with the preferred embodiment of the present invention;

FIG. 5 is an operational view in accordance with the present invention of showing that the telescopic tool pen with an illumination device is used to attract an accessory lost in a hole;

FIG. 6 is another operational view in accordance with the present invention of showing that the telescopic tool pen with an illumination device is applied for writing purposes; and

FIG. 7 shows that the magnetic member is installed in a periphery of the lampshade.

### DETAILED DESCRIPTION OF THE PREFERRED EMBODIMENTS

The present invention will become more obvious from the following description when taken in connection with the accompanying drawings, which show, for purpose of illustrations only, the preferred embodiments in accordance with the present invention.

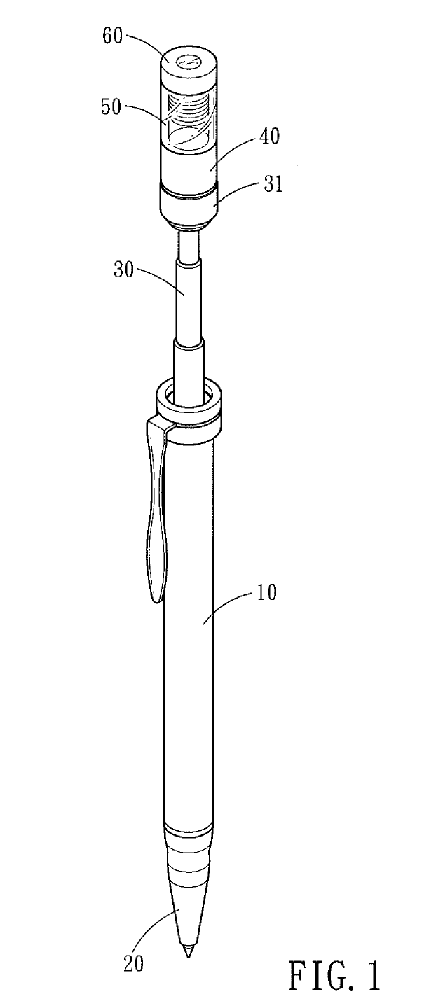

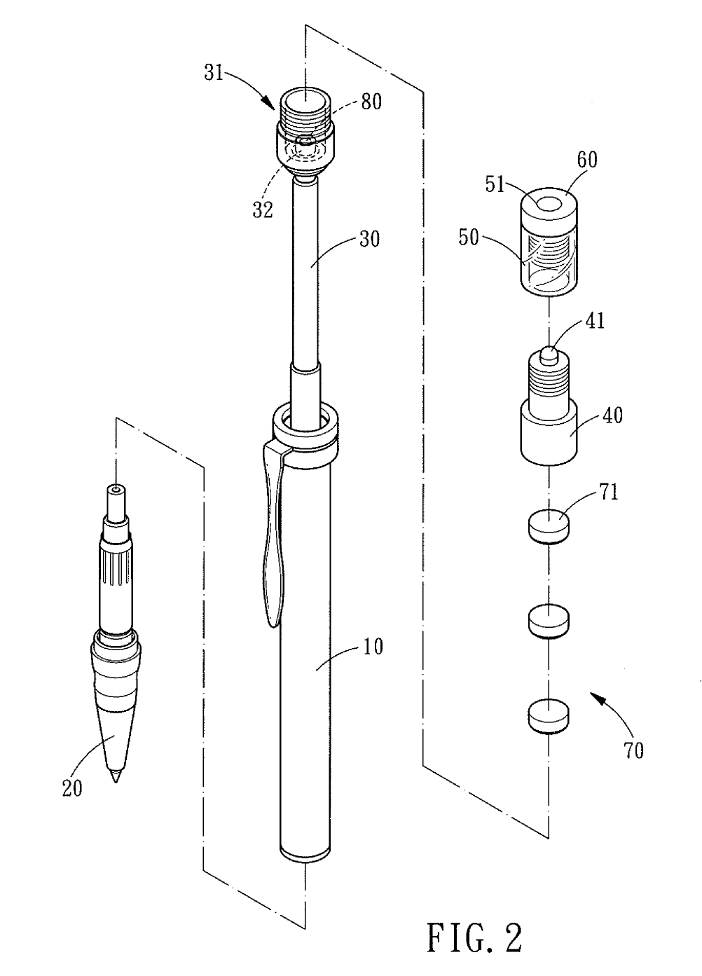

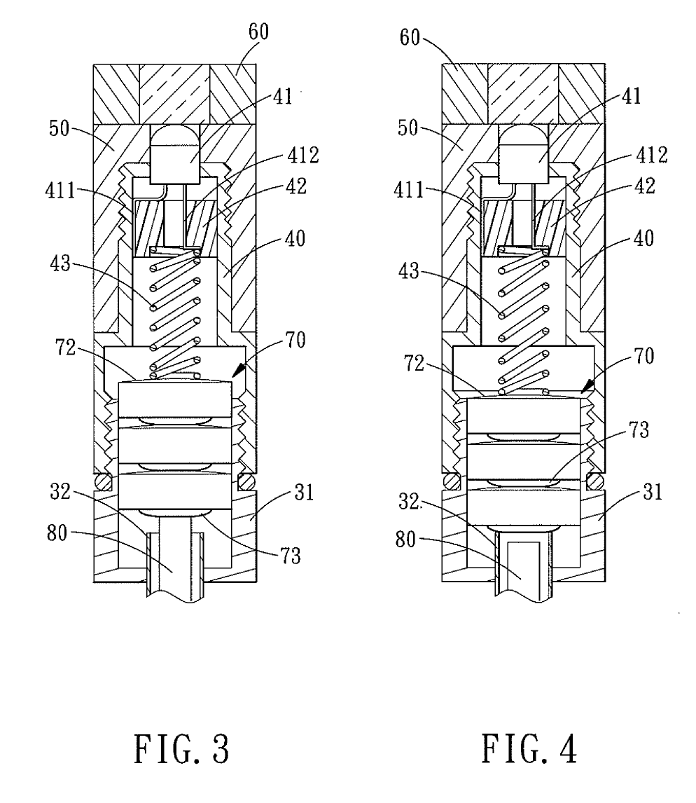

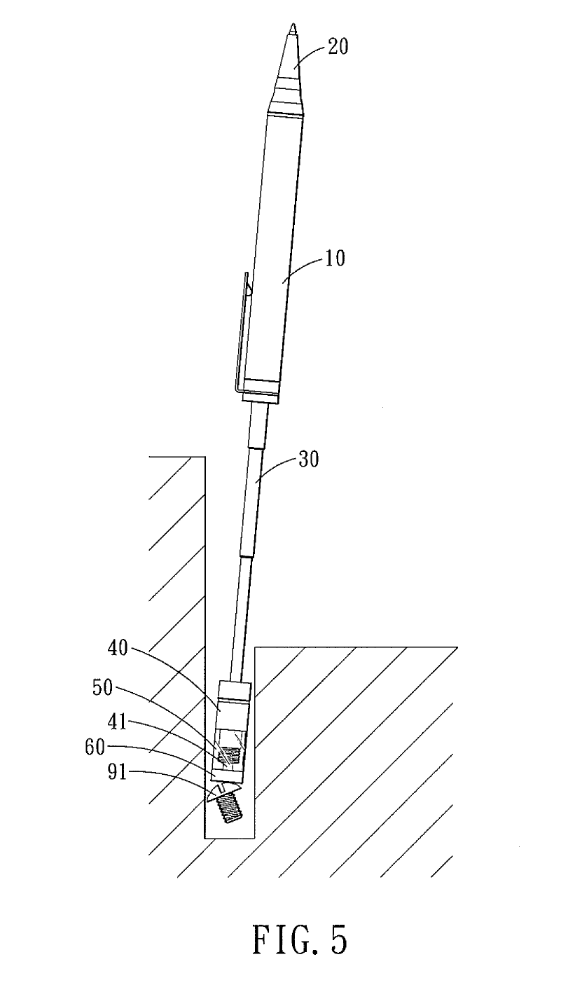

Referring initially to FIGS. 1-3, a telescopic tool pen with an illumination device in accordance with a preferred embodiment of the present invention is shown and comprises: a tube 10, a pen head 20, a telescopic pipe 30, a lamp holder 40, a lampshade 50, a magnetic member 60, a battery assembly 70 and an actuator 80.

The pen head 20 is inserted in one end of the tube 10.

The telescopic pipe 30 is conductive and is inserted in the other end of the tube 10. A mounting seat 31 is formed at one end of the telescopic pipe 30, a ring 32 is received in the mounting seat 31, and a threaded structure is formed in the outer periphery of the mounting seat 31.

The lamp holder 40 is conductive and has one end screwed on the threaded structure of the mounting seat 31 of the telescopic pipe 30. A LED (light emitting diode) 41 having two electrodes 411 and 412 is installed on the other end of the lamp holder 40, and a threaded structure in formed in the other end of the lamp holder 40. A positioning tube 42 and a spring 43 are disposed in the lamp holder 40. The outer periphery of the positioning tube 42 abuts against the inner periphery of the lamp holder 40 and presses against the electrode 411 of the LED 41, for making electrical contact with the inner periphery of the lamp holder 40 and the electrode 411 of the LED 41. The electrode 412 is inserted in the positioning tube 42. One end of the spring 43 is positioned in the positioning tube 42 and makes electrical contact with the electrode 412 of the LED 41.

The lampshade 50 is screwed on the lamp holder 40 and encapsulates the LED 41. An annular mounting recess 51 is formed in one end of the lampshade 50.

The magnetic member 60 is an annular structure disposed in the annular mounting recess 51 of the lampshade 50.

The battery assembly 70 is arranged between the lamp holder 40 and the mounting seat 31 of the telescopic pipe 30, and includes three series-connected mercury cells 71. A first electrode 72 of the battery assembly 70 is in electrical contact with the spring and is pressed against it.

The actuator 80 is a nonconductive plastic member disposed in the telescopic pipe 30, and one end of the actuator 80 protrudes out of the ring 32 and is pressed against the second electrode 73 of the battery assembly 70.

For a better understanding of the present invention, its operation and function, reference should be made to FIGS. 1, 3 and 4.

When the user want to attract and fetch an accessory 91 out of a hole 91, he/she can pull out the telescopic pipe 30, so that the actuator 80 originally protruded out of the ring 32 and was pressed against the second electrode 73 of the battery assembly 70 will be withdrawn into the telescopic pipe 30 completely. At the moment, the battery assembly 70 is not pressed against the actuator 80, and the spring 43 pushes the two electrodes 73 of the battery assembly 70 into electrical contact with the ring 32 of the telescopic pipe 30, and thus forming a conductive loop, since the telescopic pipe 30 and the lamp holder 40 are conductive.

Hence, when the tool pen with an illumination device is used to attract the accessory 91 in the hole 91, the LED 41 can illuminate the location of the accessory 91, allowing the user to attract the accessory 91 with the annular magnetic member 60 very conveniently.

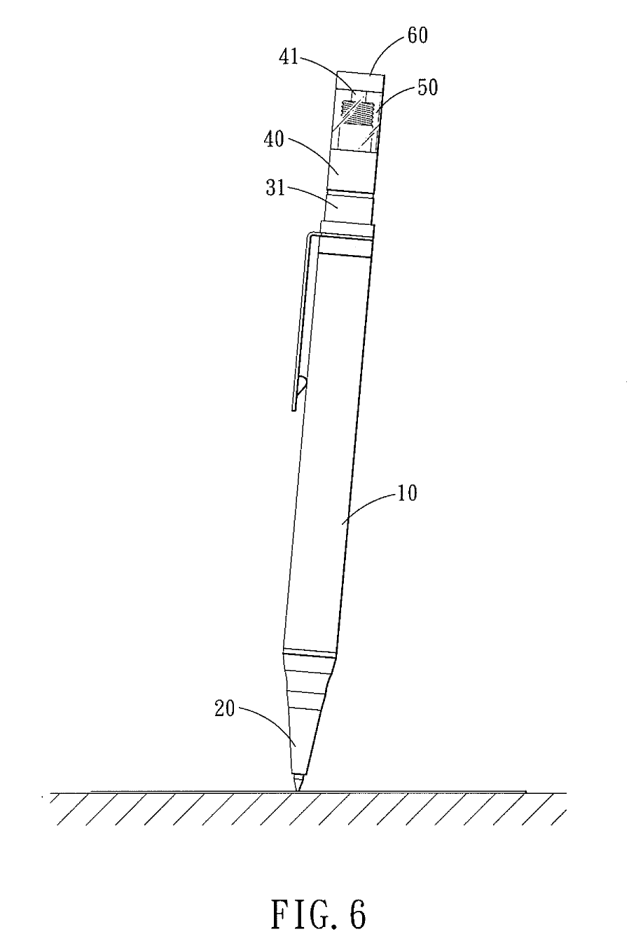

Referring to FIG. 6, the pen head 20 of the tool pen in accordance with the present invention also can be applied for writing purposes.

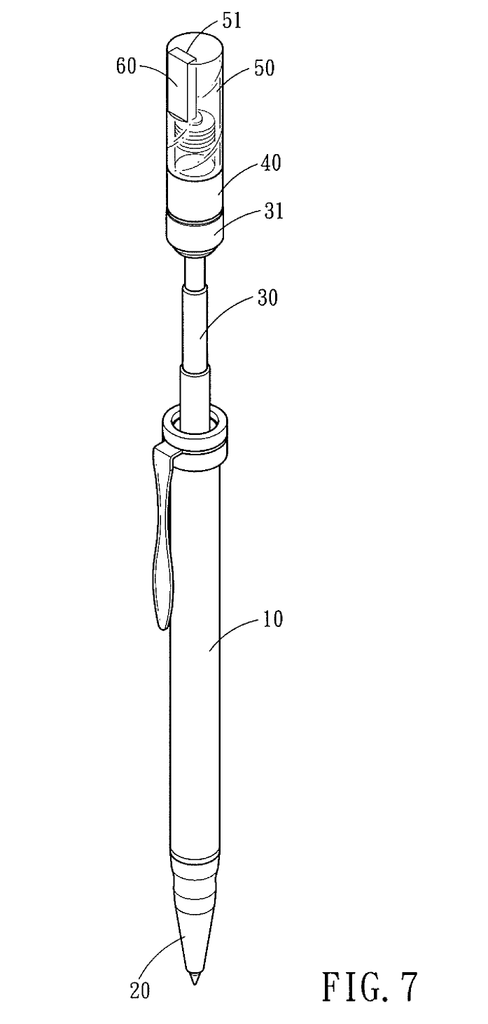

Referring to FIG. 7, the magnetic member 60 also can be block-shaped and is received in a mounting recess 51 of the lampshade 50 in such a manner that one end of the magnetic member 60 is flush with the end surface of the lampshade 50. The mounting recess 51 is shaped correspondingly to the shape of the magnetic member 60 and is located in the periphery of the lampshade 50. One end of the mounting recess 51 is open.

While we have shown and described various embodiments in accordance with the present invention, it should be clear to those skilled in the art that further embodiments may be made without departing from the scope of the present invention.

What is claimed is:

1. A telescopic tool pen with an illumination device comprising:
a tube;
a pen head inserted in one end of the tube;
a telescopic pipe inserted in the other end of the tube, a mounting seat formed at one end of the telescopic pipe, a ring received in the mounting seat;
a lamp holder installed on the mounting seat of the telescopic pipe, a LED (light emitting diode) with two electrodes being installed on the other end of the lamp holder, a spring disposed in the lamp holder, one electrode of the LED being electrical contact with the lamp holder, the other electrode of the LED being electrical contact with the spring;
a lampshade installed on the lamp holder for encapsulating the LED (light emitting diode), a mounting recess formed in the lampshade;
a magnetic member disposed in the mounting recess of the lampshade;
a battery assembly being arranged between the lamp holder and the telescopic pipe and having a first electrode and a second electrode, and the first electrode of the battery assembly being in electrical contact with and pressed against the spring; and
an actuator being disposed in the telescopic pipe in such a manner that one end of the actuator protrudes out of the ring and is pressed against the second electrode of the battery assembly, after the telescopic pipe extends out, the actuator will be withdrawn into the telescopic tube, and the spring will push the battery assembly into electrical contact with the ring of the telescopic pipe.

2. The telescopic tool pen with an illumination device as claimed in claim 1 further comprising a positioning tube disposed in the lamp holder, and an outer periphery of the positioning tube abuts against one of the electrodes of the LED (light emitting diode), and another one of the electrodes of the LED is positioned in the positioning tube and in electrical contact with the spring.

3. The telescopic tool pen with an illumination device as claimed in claim 1, wherein the battery assembly includes three series-connected mercury cells.

4. The telescopic tool pen with an illumination device as claimed in claim 1, wherein the mounting recess of the lampshade is annular-shaped and is located in the end of the lampshade, and the magnetic member is annular-shaped and is received in the annular mounting recess of the lampshade.

5. The telescopic tool pen with an illumination device as claimed in claim 1, wherein the mounting recess is formed in a periphery of the lampshade, one end of the mounting recess is open, the magnetic member is block-shaped and received in the mounting recess of the lampshade in such a manner that one end of the magnetic member is flush with an end surface of the lampshade.
